(19) United States
(12) Patent Application Publication
(10) Pub. No.: US 2025/0253901 A1
(43) Pub. Date: Aug. 7, 2025

(54) CHANNEL STATE INFORMATION PROCESSING METHODS AND APPARATUSES

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 18/855,865

(22) PCT Filed: Apr. 12, 2022
(86) PCT No.: PCT/CN2022/086462

§ 371 Date: Oct. 10, 2024

(51) Int. Cl. H04B 7/0417; H04B 7/0456; H04B 7/06

(52) U.S. Cl. CPC H04B 7/0417; H04B 7/0456; H04B 7/0626; H04B 7/0658

(57) ABSTRACT

Provided are channel state information processing methods and apparatuses. The method includes: determining a target compression algorithm; compressing Channel State Information (CSI) using the target compression algorithm to obtain compressed CSI; and sending the compressed CSI to a network device.

### CROSS REFERENCE TO RELATED APPLICATION

The present application is a U.S. National Stage of International Application No. PCT/CN2022/086462, filed on Apr. 12, 2022, the contents of which are incorporated herein by reference in its entirety.

### TECHNICAL FIELD

The present disclosure relates to the communication technical field, and in particular to a channel state information processing method and apparatus.

### BACKGROUND

In a Multiple Input Multiple Output (MIMO) system, a radio channel has random, complex and changing characteristics, and there are various serious interferences in the channel. For a downlink of a multi-user MIMO system, a base station sends signals of multiple users on the same time-frequency resource, which cause interference between users. Precoding is a key technology for MIMO downlink. A terminal device usually feeds back a channel response matrix a network device in the form of Channel State Information (CSI). The network device can perform precoding through the channel response matrix to concentrate signal energy near a target user, thereby effectively overcoming attenuation and loss, and improving system performance.

### SUMMARY

Embodiments of the present disclosure provide channel state information processing methods and apparatuses.

In a first aspect, an embodiment of the present disclosure provides a channel state information processing method. The method is performed by a terminal device, and the method includes:

determining a target compression algorithm;

compressing Channel State Information (CSI) using the target compression algorithm to obtain compressed CSI; and

sending the compressed CSI to a network device.

In a second aspect, an embodiment of the present disclosure provides a channel state information processing method. The method is performed by a network device, and the method includes:

receiving compressed CSI sent by a terminal device, wherein the compressed CSI is obtained by the terminal device through compression of CSI using a target compression algorithm.

In a third aspect, an embodiment of the present disclosure provides a communication apparatus which is provided in a terminal device, and the communication apparatus includes:

a processing module configured to: determine a target compression algorithm; and compress Channel State Information (CSI) using the target compression algorithm to obtain compressed CSI; and

a transceiving module configured to send the compressed CSI to a network device.

In a fourth aspect, an embodiment of the present disclosure provides a communication apparatus which is arranged in a network device, and the communication apparatus includes:

a transceiving module configured receive compressed CSI sent by a terminal device, wherein the compressed CSI is obtained by the terminal device through compression of CSI using a target compression algorithm.

In a fifth aspect, an embodiment of the present disclosure provides a communication apparatus, which includes a processor. When the processor executes a computer program in a memory, the method described in the first aspect is implemented.

In a sixth aspect, an embodiment of the present disclosure provides a communication apparatus, which includes a processor. When the processor executes a computer program in a memory, the method described in the second aspect is implemented.

In a seventh aspect, an embodiment of the present disclosure provides a communication apparatus, which includes a processor and a memory. A computer program is stored in the memory. The processor executes the computer program stored in the memory to cause the communication apparatus to perform the method described in the first aspect.

In an eighth aspect, an embodiment of the present disclosure provides a communication apparatus, which includes a processor and a memory. A computer program is stored in the memory. The processor executes the computer program stored in the memory to cause the communication apparatus to perform the method described in the second aspect.

In a ninth aspect, an embodiment of the present disclosure provides a communication apparatus, which includes a processor and an interface circuit. The interface circuit is configured to receive code instructions and transmit them to the processor. The processor is configured to run the code instructions to cause the apparatus to perform the method described in the first aspect.

In a tenth aspect, an embodiment of the present disclosure provides a communication apparatus, which includes a processor and an interface circuit. The interface circuit is configured to receive code instructions and transmit them to the processor. The processor is configured to run the code instructions to cause the apparatus to perform the method described in the second aspect.

In an eleventh aspect, an embodiment of the present disclosure provides a communication system. The system includes the communication apparatus described in the third aspect and the communication apparatus described in the fourth aspect, or the system includes the communication apparatus described in the fifth aspect and the communication apparatus described in the sixth aspect, or the system includes the communication apparatus described in the seventh aspect and the communication apparatus described in the eighth aspect, or the system includes the communication apparatus described in the ninth aspect and the communication apparatus described in the tenth aspect.

In a twelfth aspect, an embodiment of the present disclosure provides a non-transitory computer-readable storage medium storing instructions for the above-mentioned terminal device. When the instructions are executed, the terminal device is caused to perform the method described in the first aspect.

In a thirteenth aspect, an embodiment of the present disclosure provides a non-transitory computer-readable storage medium storing instructions for the above-mentioned network device. When the instructions are executed, the network device is caused to perform the method described in the second aspect.

In a fourteenth aspect, the present disclosure further provides a computer program product including a computer program. When the computer program is run on a computer, the computer is caused to perform the method described in the first aspect.

In a fifteenth aspect, the present disclosure further provides a computer program product including a computer program. When the computer program is run on a computer, the computer is caused to perform the method described in the second aspect.

In a sixteenth aspect, the present disclosure provides a chip system, which includes at least one processor and an interface, and is configured to support a terminal device to implement the functions involved in the first aspect, for example, determining or processing at least one of data and information involved in the above method. In an embodiment, the chip system further includes a memory, and the memory is configured to store computer programs and data necessary for the terminal device. The chip system can be formed by a chip, or the chip system can include a chip and discrete device(s).

In a seventeenth aspect, the present disclosure provides a chip system, which includes at least one processor and an interface, and is configured to support a network device to implement the functions involved in the second aspect, for example, determining or processing at least one of the data and information involved in the above method. In an embodiment, the chip system also includes a memory, and the memory is configured to store computer programs and data necessary for the network device. The chip system can be formed by a chip, or the chip system can include a chip and discrete device(s).

In an eighteenth aspect, the present disclosure provides a computer program. When the computer program is run on a computer, the computer is caused to perform the method described in the first aspect.

In a nineteenth aspect, the present disclosure provides a computer program. When the computer program is run on a computer, the computer is caused to perform the method described in the second aspect.

### BRIEF DESCRIPTION OF THE DRAWINGS

In order to more clearly illustrate the technical solutions in the embodiments of the present disclosure or the background technology, the drawings required for use in the embodiments of the present disclosure or the background technology will be described below.

FIG. 1 is a schematic diagram of the architecture of a communication system provided by an embodiment of the present disclosure;

FIG. 2 is a schematic flowchart of a channel state information processing method provided by an embodiment of the present disclosure;

FIG. 3 is a schematic flowchart of another channel state information processing method provided by an embodiment of the present disclosure;

FIG. 4 is a schematic flowchart of another channel state information processing method provided by an embodiment of the present disclosure;

FIG. 5 is a schematic flowchart of another channel state information processing method provided by an embodiment of the present disclosure;

FIG. 6 is a schematic flowchart of another channel state information processing method provided by an embodiment of the present disclosure;

FIG. 7 is a schematic flowchart of another channel state information processing method provided by an embodiment of the present disclosure;

FIG. 8 is a schematic flowchart of another channel state information processing method provided by an embodiment of the present disclosure;

FIG. 9 is a schematic flowchart of another channel state information processing method provided by an embodiment of the present disclosure;

FIG. 10 is a schematic flowchart of another channel state information processing method provided by an embodiment of the present disclosure;

FIG. 11 is a schematic flowchart of another channel state information processing method provided by an embodiment of the present disclosure;

FIG. 12 is a schematic flowchart of another channel state information processing method provided by an embodiment of the present disclosure;

FIG. 13 is a schematic flowchart of another channel state information processing method provided by an embodiment of the present disclosure;

FIG. 14 is a schematic flowchart of another channel state information processing method provided by an embodiment of the present disclosure;

FIG. 15 is a schematic flowchart of another channel state information processing method provided by an embodiment of the present disclosure;

FIG. 16 is a schematic diagram of the structure of a communication apparatus provided by an embodiment of the present disclosure;

FIG. 17 is a schematic diagram of the structure of another communication apparatus provided by an embodiment of the present disclosure;

FIG. 18 is a schematic diagram of the structure of a chip provided by an embodiment of the present disclosure.

### DETAILED DESCRIPTION

For ease of understanding, the terms involved in the present disclosure are first introduced.

### 1. Channel Response Matrix

The channel response matrix is obtained by a terminal device through channel estimation, and a network device can generate a precoding matrix based on the channel response matrix.

### 2. Precoding

Precoding is a key technology for MIMO downlink. By using channel information, preprocessing is performed at a network device side to adapt to a corresponding channel environment, thereby improving system performance.

In order to better understand a channel state information processing method disclosed in an embodiment of the present disclosure, a communication system to which the embodiment of the present disclosure is applicable is first described below.

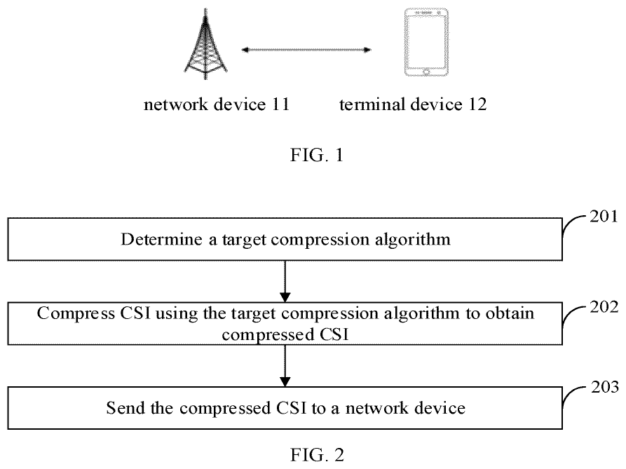

FIG. 1 is a schematic diagram of the architecture of a communication system provided by an embodiment of the present disclosure. The communication system may include but is not limited to a network device and a terminal device. The number and form of devices shown in FIG. 1 are only used for illustration and do not constitute a limitation on the embodiments of the present disclosure. In actual applications, two or more network devices, and two or more terminal devices may be included. The communication system shown in FIG. 1 includes a network device 11, and a terminal device 12 as an example.

It should be noted that the technical solutions of the embodiments of the present disclosure may be applied to various communication systems, such as a Long Term Evolution (LTE) system, a fifth generation (5G) mobile communication system, a 5G New Radio (NR) system, or other future new mobile communication systems, and so on.

The network device 11 in the embodiment of the present disclosure is an entity at the network side for transmitting or receiving signals. For example, the network device 11 may be an evolved base station (evolved NodeB, eNB), a Transmission Reception Point (TRP), a next generation NodeB (gNB) in the NR system, a base station in other future mobile communication system(s), or an access node in a Wireless Fidelity (WiFi) system. The embodiment of the present disclosure does not limit the specific technology and specific device form adopted by the network device. The network device provided in the embodiment of the present disclosure may be formed by a Central Unit (CU) and a Distributed Unit (DU). The CU may also be referred to as a control unit. The CU-DU structure may be used to split the protocol layer(s) of the network device, such as a base station, and the functions of some protocol layers are placed in the CU for centralized control, and the functions of the remaining part or all of the protocol layers are distributed in the DU, and the DU is centrally controlled by the CU.

The terminal device 12 in the embodiment of the present disclosure is an entity at the user side for receiving or transmitting signals, such as a mobile phone. The terminal device may also be called a terminal, User Equipment (UE), a Mobile Station (MS), a Mobile Terminal (MT), etc. The terminal device may be a car with a communication function, a smart car, a mobile phone, a wearable device, a tablet computer (Pad), a computer with a wireless transceiver function, a Virtual Reality (VR) terminal device, an Augmented Reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiment of the present disclosure does not limit the specific technology and specific device form adopted by the terminal device.

It can be understood that the communication system described in the embodiments of the present disclosure is for the purpose of more clearly illustrating the technical solutions of the embodiments of the present disclosure, and does not constitute a limitation on the technical solutions provided by the embodiments of the present disclosure. A person skilled in the art can know that with the evolutions of the system architecture and the emergence of new service scenarios, the technical solutions provided by the embodiments of the present disclosure are also applicable to similar technical problems.

In the related art, in order to reduce the number of CSI feedback bits, a terminal device can compress CSI. Due to the complex and changing characteristics of radio channels, if only one compression algorithm is used to compress the CSI, in order to improve its generalization ability, the accuracy and compression efficiency will be reduced. In the present disclosure, a target compression algorithm can be determined and the CSI can be compressed using the target compression algorithm, thereby selecting a suitable compression algorithm to compress the CSI. This method can improve the accuracy and compression efficiency. The following is a detailed introduction to a channel state information processing method and apparatus provided by the present disclosure in conjunction with the accompanying drawings. FIG. 2 is a schematic flowchart of a channel state information processing method provided by an embodiment of the present disclosure. The method is performed by a terminal device. As shown in FIG. 2, the method may include but is not limited to the following steps:

In step 201, a target compression algorithm is determined.

In the present disclosure, a plurality of compression algorithms for compressing CSI may be pre-configured in the terminal device. The terminal device may determine a target compression algorithm from the plurality of compression algorithms. Since the radio channel has complex and changing characteristics, the terminal device may determine the target compression algorithm from the plurality of compression algorithms according to scenario information of a scenario in which the terminal device is currently located, or a compression requirement, etc.

The compression algorithm in the present disclosure may be an artificial intelligence (AI) compression algorithm, such as a Convolutional Neural Network (CNN), a Recurrent Neural Network (RNN), a Long Short-Term Memory (LSTM) network, etc.

In step 202, CSI is compressed using the target compression algorithm to obtain compressed CSI.

After determining the target compression algorithm, the terminal device may use the compression algorithm to compress the CSI to obtain compressed CSI, so that the number of bits of the compressed CSI is reduced compared to the number of bits of the CSI before compression, thereby improving transmission efficiency.

In step 203, the compressed CSI is sent to a network device.

After obtaining the compressed CSI, the terminal device may send the compressed CSI to the network device.

In the present disclosure, the terminal device determines the target compression algorithm, compresses the CSI using the target compression algorithm to obtain compressed CSI, and sends the compressed CSI to the network device. In this way, the terminal device can select a suitable compression algorithm to compress the CSI, thereby improving accuracy and compression efficiency.

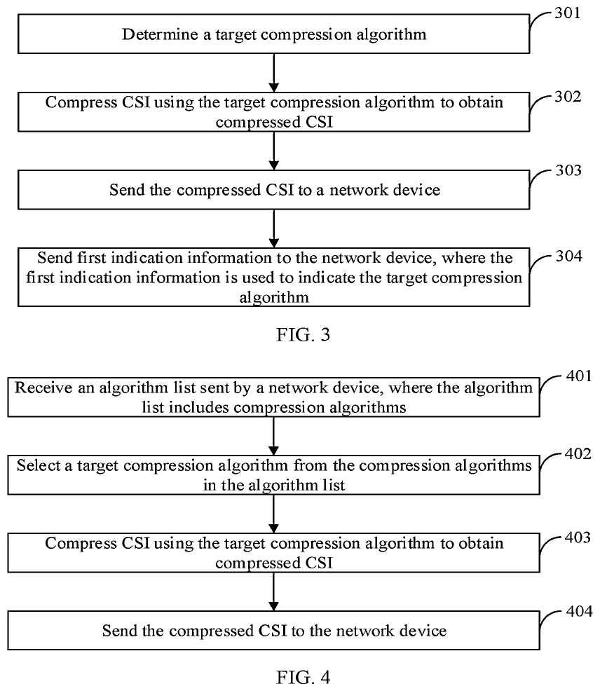

FIG. 3 is a schematic flowchart of another channel state information processing method provided by an embodiment of the present disclosure. The method is performed by a terminal device. As shown in FIG. 3, the method may include but is not limited to the following steps:

In step 301, a target compression algorithm is determined.

In step 302, CSI is compressed using a target compression algorithm to obtain compressed CSI.

In step 303, the compressed CSI is sent to a network device.

In the present disclosure, for the specific implementations of step 301 to step 303, reference may be made to the detailed descriptions of any embodiment of the present disclosure, and repeated descriptions will be omitted here.

In step 304, first indication information is sent to the network device, where the first indication information is used to indicate the target compression algorithm.

In the present disclosure, the terminal device may send first indication information to the network device, where the first indication information may be used to indicate the target compression algorithm. That is, the terminal device indicates to the network device through the first indication information the target compression algorithm used for compressing CSI. In this way, the network device can determine the compression algorithm used by the terminal device for compressing CSI based on the first indication information, and the network device can decompress the compressed CSI based on the target compression algorithm to obtain the CSI before compression.

It should be noted that the above steps 303 to 304 can be performed in sequence according to the above order, or step 304 may be performed first and then step 303 is performed, or step 303 and step 304 may be performed in parallel, which is not limited in the present disclosure.

In the present disclosure, the terminal device can determine the target compression algorithm, compress the CSI using the target compression algorithm to obtain the compressed CSI, and send the compressed CSI to the network device. And, the terminal device can also send the first indication information indicating the target compression algorithm to the network device. Thus, the terminal device can select a suitable compression algorithm to compress the CSI, thereby improving the accuracy and compression efficiency. And, sending the indication information indicating the target compression algorithm to the network device can enable the network device to decompress the compressed CSI according to the target compression algorithm indicated in the indication information.

FIG. 4 is a schematic flowchart of another channel state information processing method provided by an embodiment of the present disclosure. The method is performed by a terminal device. As shown in FIG. 4, the method may include but is not limited to the following steps:

In step 401, an algorithm list sent by a network device is received, where the algorithm list includes compression algorithms.

In the present disclosure, an algorithm list is configured in the network device, where the algorithm list may include compression algorithms for compressing CSI. The network device may send the algorithm list to the terminal device, so that the terminal device may receive the algorithm list sent by the network device.

In the present disclosure, the terminal device may be configured with usage conditions corresponding to compression algorithms in the algorithm list, and the usage conditions corresponding to compression algorithms may include one or more of the following: a reference signal quality condition, a position condition, a time condition, a beam identity, a cell identity, an antenna port, number of transmission layers, a modulation order, etc.

The reference signal quality condition includes one or more of the following: being within a preset range of a channel quality; being within a preset range of Reference Signal Receiving Power (RSRP); being within a preset range of Reference Signal Receiving Quality (RSRQ); being within a preset range of Signal to Interference plus Noise Ratio (SINR).

The position condition may be that the position of the terminal device is within a corresponding position range. The time condition may be that the current time is within a corresponding time range. For example, different compression algorithms correspond to different time periods, and the time condition of a compression algorithm is that the current time is within a time period corresponding to the compression algorithm.

In step 402, a target compression algorithm is selected from the compression algorithms in the algorithm list.

In the present disclosure, the usage conditions of compression algorithms in the algorithm list may be configured in the terminal device, and the terminal device may determine which compression algorithm's usage condition is satisfied according to the usage conditions of the compression algorithms, and the compression algorithm may be determined as the target compression algorithm. If the usage conditions corresponding to multiple compression algorithms are satisfied at the same time, one of the multiple compression algorithms whose usage conditions are satisfied can be randomly selected as the target compression algorithm.

In step 403, the CSI is compressed using the target compression algorithm to obtain compressed CSI.

In step 404, the compressed CSI is sent to the network device.

In the present disclosure, for the specific implementations of step 403 to step 404, reference may be made to the detailed descriptions of any embodiment of the present disclosure, and repeated descriptions will be omitted here.

Optionally, the terminal device may also send first indication information to the network device. The first indication information may be an index identity. The index identity is used to indicate a position of the target compression algorithm in the algorithm list. That is, when the terminal device indicates to the network device the target compression algorithm for compressing the CSI, the terminal device may indicate to the network device the position of the target compression algorithm in the algorithm list. Thus, the network device can determine, based on the index identity, the compression algorithm used by the terminal device to compress the CSI.

It should be noted that the compressed CSI may be sent to the network device first, and then the first indication information is sent. Alternatively, the first indication information may be sent first and then the compressed CSI is sent. Alternatively, the compressed CSI and the first indication information may be sent at the same time. The present disclosure does not limit this.

In the present disclosure, the terminal device receives the algorithm list sent by the network device, selects the target compression algorithm from the compression algorithms in the algorithm list, compresses the CSI using the target compression algorithm to obtain the compressed CSI, and sends the compressed CSI to the network device. Thus, the terminal device can select a suitable compression algorithm from the algorithm list, and compress the CSI using the suitable compression algorithm, thereby improving accuracy and compression efficiency.

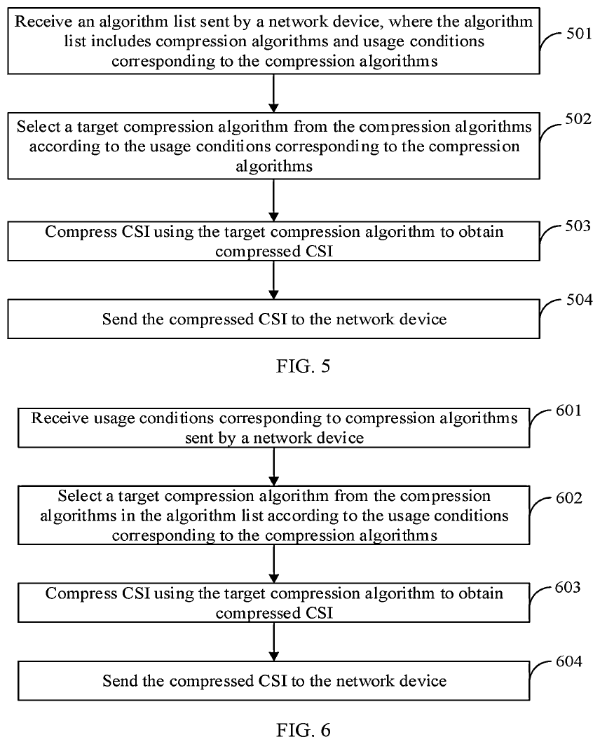

FIG. 5 is a schematic flowchart of another channel state information processing method provided by an embodiment of the present disclosure. The method is performed by a terminal device. As shown in FIG. 5, the method may include but is not limited to the following steps:

In step 501, an algorithm list sent by a network device is received, where the algorithm list includes compression algorithms and usage conditions corresponding to the compression algorithms.

In the present disclosure, the network device is configured with an algorithm list. The algorithm list may include compression algorithms for compressing CSI and usage conditions corresponding to the compression algorithms. The network device may send the algorithm list to the terminal device, and the terminal device may receive the algorithm list sent by the network device.

For the specific explanations regarding usage conditions corresponding to compression algorithms in the present disclosure, reference may be made to the detailed descriptions of any embodiment of the present disclosure, and repeated descriptions will be omitted here.

In step 502, a target compression algorithm is selected from the compression algorithms according to the usage conditions corresponding to the compression algorithms.

In the present disclosure, the terminal device can determine which compression algorithm's usage condition is satisfied according to the usage condition corresponding to each compression algorithm in the algorithm list, and determine the compression algorithm as the target compression algorithm. If the usage conditions corresponding to multiple compression algorithms are satisfied at the same time, one of the compression algorithms whose usage conditions are satisfied can be randomly selected as the target compression algorithm.

In step 503, the CSI is compressed using the target compression algorithm to obtain compressed CSI.

In step 504, the compressed CSI is sent to the network device.

In the present disclosure, for the specific implementations of step 503 to step 504, reference may be made to detailed descriptions of any embodiment of the present disclosure, and repeated descriptions will be omitted here.

Optionally, the terminal device may also send first indication information to the network device. The first indication information may be an index identity. The index identity is used to indicate a position of the target compression algorithm in the algorithm list. That is, when the terminal device indicates to the network device the target compression algorithm used for compressing the CSI, the terminal device may indicate to the network device the position of the target compression algorithm in the algorithm list. Thus, the network device can determine, based on the index identity, the compression algorithm used by the terminal device for compressing the CSI.

It should be noted that the compressed CSI may be sent to the network device first, and then the first indication information is sent. Alternatively, the first indication information may be sent first, and then the compressed CSI is sent. Alternatively, the compressed CSI and the first indication information may be sent at the same time. The present disclosure does not limit this.

In the present disclosure, the terminal device receives the algorithm list sent by the network device, and the algorithm list includes compression algorithms and usage conditions of the compression algorithms. The terminal device selects the target compression algorithm from the compression algorithms according to the usage conditions corresponding to the compression algorithms, and compresses the CSI using the target compression algorithm to obtain compressed CSI, and sends the compressed CSI to the network device. Thus, the terminal device can select a suitable compression algorithm from the algorithm list, and compress the CSI using the suitable compression algorithm, thereby improving accuracy and compression efficiency.

FIG. 6 is a schematic flowchart of another channel state information processing method provided by an embodiment of the present disclosure. The method is performed by a terminal device. As shown in FIG. 6, the method may include but is not limited to the following steps:

In step 601, usage conditions corresponding to compression algorithms sent by a network device is received.

In the present disclosure, an algorithm list may be configured in the terminal device, and the algorithm list includes compression algorithms for compressing CSI. The network device may send usage conditions of the compression algorithms to the terminal device, so that the terminal device can obtain usage conditions corresponding to the compression algorithms.

For the specific explanations regarding the usage conditions corresponding to the compression algorithms, reference may be made to the detailed explanations of any embodiment of the present disclosure, and repeated descriptions will be omitted here.

In step 602, a target compression algorithm is selected from the compression algorithms in the algorithm list according to the usage conditions corresponding to the compression algorithms.

In the present disclosure, the terminal device may determine which compression algorithm's usage condition is satisfied according to the usage condition of each compression algorithm, and determine the compression algorithm as the target compression algorithm. If the usage conditions corresponding to multiple compression algorithms are satisfied at the same time, one of the compression algorithms whose usage conditions are satisfied may be randomly selected as the target compression algorithm.

In step 603, the CSI is compressed using the target compression algorithm to obtain compressed CSI.

In step 604, the compressed CSI is sent to the network device.

In the present disclosure, for the specific implementations of step 603 to step 604, reference may be made to the detailed descriptions of any embodiment of the present disclosure, and repeated descriptions will be omitted here.

Optionally, the terminal device may also send first indication information to the network device. The first indication information may be an index identity. The index identity is used to indicate the position of the target compression algorithm in the algorithm list. That is, when the terminal device indicates to the network device the target compression algorithm used for compressing the CSI, the terminal device may indicate to the network device the position of the target compression algorithm in the algorithm list. Thus, the network device can determine, based on the index identity, the compression algorithm used by the terminal device for compressing the CSI.

It should be noted that the compressed CSI may be sent to the network device first, and then the first indication information is sent. Alternatively, the first indication information may be sent first, and then the compressed CSI is sent. Alternatively, the compressed CSI and the first indication information may be sent at the same time. The present disclosure does not limit this.

In the present disclosure, the terminal device receives the usage conditions corresponding to the compression algorithms sent by the network device, selects the target compression algorithm from the compression algorithms in the algorithm list according to the usage conditions corresponding to the compression algorithms, compresses CSI using the target compression algorithm to obtain compressed CSI, and sends the compressed CSI to the network device. Thus, the terminal device can determine a suitable compression algorithm according to the usage conditions of the compression algorithms, and compress the CSI using the suitable compression algorithm, thereby improving accuracy and compression efficiency.

In an embodiment of the present disclosure, an algorithm list may be configured in the network device, the algorithm list includes compression algorithms for compressing CSI, and usage conditions of the compression algorithms are also configured. The network device can send the algorithm list and the usage conditions corresponding to the compression algorithms to the terminal device, and the terminal device can receive the algorithm list and the conditions corresponding to the compression algorithms in the algorithm list sent by the network device. The terminal device can determine the target compression algorithm from the algorithm list according to the usage conditions corresponding to the compression algorithms, compress the CSI using the target compression algorithm, and send the compressed CSI to the network device.

Optionally, the terminal device may also send first indication information to the network device. The first indication information may be an index identity. The index identity is used to indicate the position of the target compression algorithm in the algorithm list. That is, when the terminal device indicates to the network device the target compression algorithm used for compressing the CSI, the terminal device may indicate to the network device the position of the target compression algorithm in the algorithm list. Thus, the network device can determine, based on the index identity, the compression algorithm used by the terminal device for compressing the CSI.

It should be noted that the compressed CSI may be sent to the network device first, and then the first indication information is sent. Alternatively, the first indication information may be sent first, and then the compressed CSI is sent. Alternatively, the compressed CSI and the first indication information may be sent at the same time. The present disclosure does not limit this.

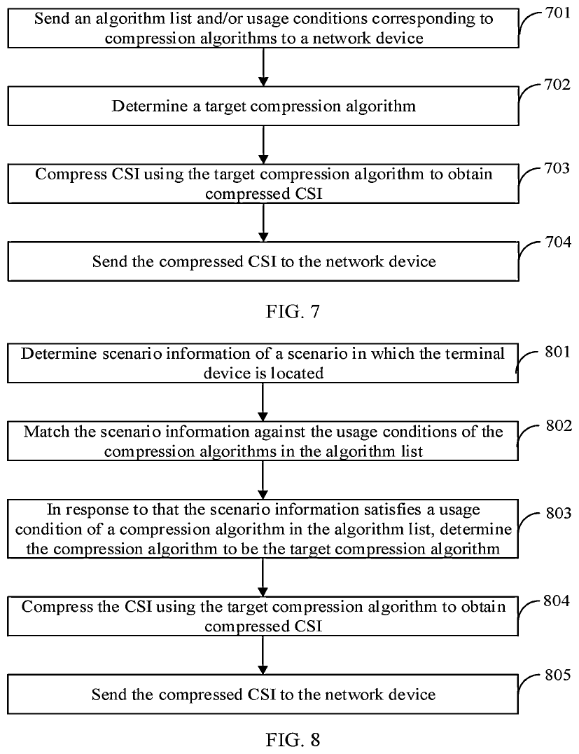

FIG. 7 is a schematic flowchart of another channel state information processing method provided by an embodiment of the present disclosure. The method is performed by a terminal device. As shown in FIG. 7, the method may include but is not limited to the following steps:

In step 701, an algorithm list and/or usage conditions corresponding to compression algorithms are sent to a network device.

In the present disclosure, an algorithm list may be configured in the terminal device. The algorithm list may include compression algorithms for compressing CSI, usage conditions corresponding to the compression algorithms, etc. The terminal device may send the algorithm list to the network device, and the network device may receive the algorithm list sent by the network device.

In the present disclosure, for the specific explanations of the usage conditions of the compression algorithms, reference may be made to the detailed explanations of any embodiment of the present disclosure, and repeated descriptions will be omitted here.

Optionally, both the terminal device and the network device may be configured with an algorithm list, where the algorithm list includes compression algorithms. The terminal device is further configured with usage conditions of compression algorithms in the algorithm list. The terminal device may send the usage conditions of the compression algorithms to the network device, so that the network device may obtain the usage conditions corresponding to the compression algorithms.

Optionally, the terminal device may be configured with an algorithm list, and the algorithm list includes compression algorithms for compressing CSI, and the terminal device is further configured with usage conditions of the compression algorithms. The terminal device may send the algorithm list and the usage conditions corresponding to the compression algorithms to the network device.

In step 702, a target compression algorithm is determined.

In step 703, the CSI is compressed using the target compression algorithm to obtain compressed CSI.

In step 704, the compressed CSI is sent to the network device.

In the present disclosure, for the specific implementations of step 702 to step 704, reference may be made to the detailed descriptions of any embodiment of the present disclosure, and repeated descriptions will be omitted here.

It should be noted that the above steps 701 to 704 may be performed in the above order, or step 701 may be performed after any step in step 702 to step 704, or may be performed simultaneously with other steps, which is not limited in the present disclosure.

Optionally, the terminal device may also send first indication information to the network device. The first indication information may be an index identity. The index identity is used to indicate the position of the target compression algorithm in the algorithm list. That is, when the terminal device indicates to the network device the target compression algorithm used for compressing the CSI, the terminal device may indicate to the network device the position of the target compression algorithm in the algorithm list. Thus, the network device may determine, based on the index identity, the compression algorithm used by the terminal device for compressing the CSI.

It should be noted that the compressed CSI may be sent to the network device first, and then the first indication information is sent. Alternatively, the first indication information may be sent first, and then the compressed CSI is sent. Alternatively, the compressed CSI and the first indication information may be sent at the same time. The present disclosure does not limit this.

In the present disclosure, the terminal device sends the algorithm list and/or the usage conditions corresponding to the compression algorithms to the network device, determines the target compression algorithm, compresses the CSI using the target compression algorithm to obtain the compressed CSI, and sends the compressed CSI to the network device. Thus, the terminal device can send the algorithm list and/or the usage conditions corresponding to the compression algorithms to the network device, and the terminal device can also determine a suitable compression algorithm from the compression algorithms, and use the suitable compression algorithm to compress the CSI, thereby improving the accuracy and compression efficiency.

FIG. 8 is a schematic flowchart of another channel state information processing method provided by an embodiment of the present disclosure. The method is performed by a terminal device. As shown in FIG. 8, the method may include but is not limited to the following steps:

In step 801, scenario information of a scenario in which the terminal device is located is determined.

In the present disclosure, the scenario information of the scenario in which the terminal device is located may include one or more of the following: information of a reference signal of a serving beam or serving cell, position information of the terminal device, time information of the terminal device, a serving beam identity, a serving cell identity, an antenna port, number of transmission layers, a modulation order, etc.

The information of the reference signal may include one or more of the following: a reference signal quality, RSRP, RSRQ, SINR, etc.

The position information of the terminal device may be a relative position or an absolute position. The relative position may be a distance between the terminal device and the network device or a distance between the terminal device and a reference point, and the absolute position may be geographical position coordinate(s) of the terminal device.

The time information of the terminal device may be absolute time or relative time. The absolute time may be the Universal Time Coordinated (UTC) time, and the relative time may be determined according to running of a timer. The start time of the timer may be UTC time, or it may be started based on an event trigger. The timer start event may be that the terminal device and the network device complete the interaction procedure of the compression algorithms and confirm receipt of the compression algorithms, or that the channel quality of the reference signal of the beam or cell meets requirement(s), etc.

In step 802, the scenario information is matched against the usage conditions of the compression algorithms in the algorithm list.

In the present disclosure, an algorithm list is stored on the terminal device, and the algorithm list may include compression algorithms for compressing CSI, usage conditions of the compression algorithms, etc. The algorithm list and/or usage conditions of the compression algorithms may be pre-configured on the terminal device, or may be received from a network device.

In the present disclosure, the scenario information of the scenario in which the terminal device is located may be matched against the usage conditions of the compression algorithms in the algorithm list to determine a compression algorithm that matches the scenario information of the scenario in which the terminal device is located.

In step 803, in response to that the scenario information satisfies a usage condition of a compression algorithm in the algorithm list, the compression algorithm is determined to be the target compression algorithm. Optionally, the terminal device may determine that a compression algorithm is the target compression algorithm in response to the information of a reference signal of the serving beam or serving cell in the scenario information satisfies the reference signal quality condition of the compression algorithm in the algorithm list.

The reference signal quality condition includes one or more of the following: being within a preset range of a channel quality; being within a preset range of RSRP; being within a preset range of RSRQ; being within a preset range of SINR.

For example, the reference signal quality condition of each compression algorithm includes being within the preset range of RSRP and being within the preset range of RSRQ. If the RSRP of the serving cell of the terminal device is within the preset range of RSRP required by a certain compression algorithm, and the RSRQ of a reference signal of the serving cell is within the preset range of RSRQ required by the compression algorithm, the terminal device can determine the compression algorithm to be the target compression algorithm.

Optionally, the terminal device may determine a compression algorithm to be the target compression algorithm in response to that the position information of the terminal device in the scenario information satisfies a position range in the usage condition of the compression algorithm in the algorithm list.

That is to say, each compression algorithm has a corresponding position range. When the position of the terminal device is within the position range corresponding to a certain compression algorithm, it can be considered that the position information of the terminal device satisfies the position range in the usage condition of the compression algorithm, and the compression algorithm is determined to be the target compression algorithm.

For example, when the distance between the terminal device and the network device is within a certain distance range, or the geographical position coordinate(s) of the terminal device is (are) preset coordinate(s), a compression algorithm A can be used.

Optionally, the terminal device may determine a compression algorithm to be the target compression algorithm in response to that the time information of the terminal device in the scenario information satisfies a time range in the usage condition of the compression algorithm in the algorithm list.

That is to say, each compression algorithm has a corresponding time range. For example, different compression algorithms can be used in different time periods. When the time of the terminal device is in the time range corresponding to a certain compression algorithm, it can be considered that the time information of the terminal device satisfies the time range in the usage condition of the compression algorithm, and the compression algorithm is determined to be the target compression algorithm.

Optionally, the terminal device may determine a compression algorithm to be the target compression algorithm in response to that one or more of a serving beam identity, a serving cell identity, an antenna port, number of transmission layers, a modulation order in the scenario information matches the usage condition of the compression algorithm in the algorithm list.

For example, the usage condition of each compression algorithm includes the number of transmission layers and the modulation order. When the number of transmission layers used by the terminal device matches the number of transmission layers in the usage condition of a compression algorithm, and the modulation order used by the terminal device also matches the modulation order in the usage condition of the compression algorithm, the compression algorithm can be determined to be the target compression algorithm.

In step 804, the CSI is compressed using the target compression algorithm to obtain compressed CSI.

In step 805, the compressed CSI is sent to the network device.

In the present disclosure, for the specific implementations of step 804 to step 805, reference may be made to the detailed descriptions of any embodiment of the present disclosure, and repeated descriptions will be omitted here.

Optionally, the terminal device may also send first indication information to the network device. The first indication information may be an index identity. The index identity is used to indicate the position of the target compression algorithm in the algorithm list. That is, when the terminal device indicates to the network device the target compression algorithm used for compressing the CSI, the terminal device may indicate to the network device the position of the target compression algorithm in the algorithm list. Thus, the network device may determine the compression algorithm used by the terminal device for compressing the CSI based on the index identity.

It should be noted that the compressed CSI may be sent to the network device first, and then the first indication information is sent. Alternatively, the first indication information may be sent first, and then the compressed CSI is sent. Alternatively, the compressed CSI and the first indication information may be sent at the same time. The present disclosure does not limit this.

In the present disclosure, the terminal device determines the scenario information of the scenario in which the terminal device is located, matches the scenario information against the usage conditions of compression algorithms in the algorithm list, and in response to that the scenario information satisfies the usage condition of a compression algorithm in the algorithm list, and determines the compression algorithm to be the target compression algorithm. The terminal device compresses the Channel State Information (CSI) using the target compression algorithm to obtain the compressed CSI, and sends the compressed CSI to the network device. Thus, according to the scenario information of the scenario in which the terminal device is located, the terminal device can select, from the compression algorithms, a compression algorithm that matches the scenario information. In this way, the terminal device can select corresponding compression algorithms to compress the CSI for different scenarios, thereby improving the accuracy and compression efficiency.

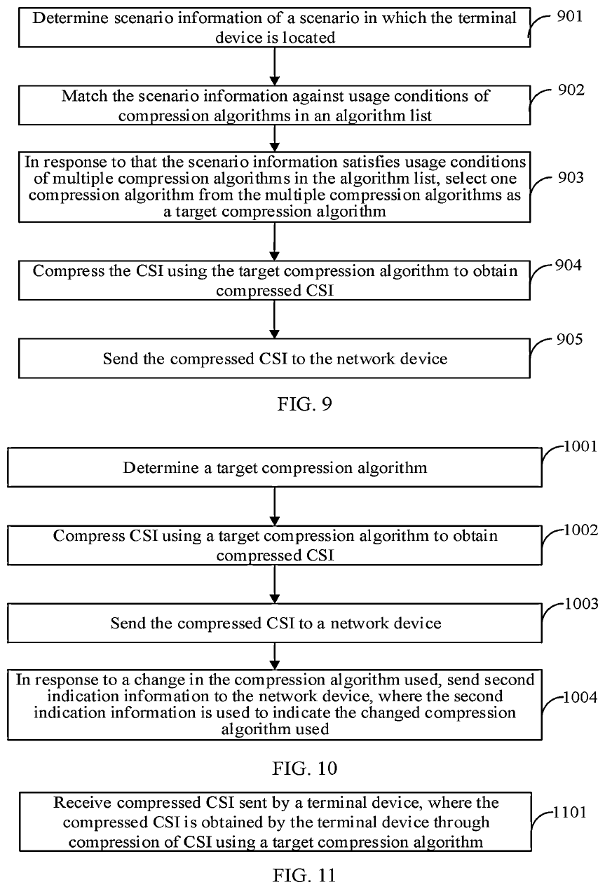

FIG. 9 is a schematic flowchart of another channel state information processing method provided by an embodiment of the present disclosure. The method is performed by a terminal device. As shown in FIG. 9, the method may include but is not limited to the following steps:

In step 901, scenario information of a scenario in which the terminal device is located is determined.

In step 902, the scenario information is matched against usage conditions of compression algorithms in an algorithm list.

In the present disclosure, for the specific implementations of step 901 to step 902, reference may be made to the detailed descriptions of any embodiment of the present disclosure, and repeated descriptions will be omitted here.

In step 903, in response to that the scenario information satisfies usage conditions of multiple compression algorithms in the algorithm list, one compression algorithm is selected from the multiple compression algorithms as a target compression algorithm.

In the present disclosure, the usage condition corresponding to each compression algorithm may include multiple conditions, and the conditional factors involved in the usage condition corresponding to each compression algorithm may also be different. For example, the usage condition corresponding to a certain compression algorithm is a reference signal quality condition, while the usage condition corresponding to another compression algorithm is a time condition. Therefore, the scenario information of the scenario in which the terminal device is located may simultaneously satisfies the usage conditions corresponding to multiple compression algorithms. When the scenario information of the scenario in which the terminal device is located satisfies the usage conditions of multiple compression algorithms in the algorithm list, one of the compression algorithms can be selected from the multiple compression algorithms as the target compression algorithm.

In step 904, the CSI is compressed using the target compression algorithm to obtain compressed CSI.

In step 905, the compressed CSI is sent to the network device.

In the present disclosure, for the specific implementations of step 904 to step 905, reference may be made to the detailed descriptions of any embodiment of the present disclosure, and repeated descriptions will be omitted here.

Optionally, the terminal device may also send first indication information to the network device. The first indication information may be an index identity. The index identity is used to indicate the position of the target compression algorithm in the algorithm list. That is, when the terminal device indicates to the network device the target compression algorithm used to compress the CSI, the terminal device may indicate to the network device the position of the target compression algorithm in the algorithm list. Thus, the network device can determine the compression algorithm used by the terminal device for compressing the CSI based on the index identity.

It should be noted that the compressed CSI may be sent to the network device first, and then the first indication information is sent. Alternatively, the first indication information may be sent first, and then the compressed CSI is sent. Alternatively, the compressed CSI and the first indication information may be sent at the same time. The present disclosure does not limit this.

In the present disclosure, the terminal device determines the scenario information of the scenario in which the terminal device is located, and matches the scenario information against the usage conditions of the compression algorithms in the algorithm list. In response to that the scenario information satisfies the usage conditions of multiple compression algorithms in the algorithm list, the terminal device selects one compression algorithm from the multiple compression algorithms as the target compression algorithm. The terminal device compresses the Channel State Information (CSI) using the target compression algorithm to obtain the compressed CSI, and sends the compressed CSI to the network device. Thus, according to the scenario information of the scenario in which the terminal device is located, the terminal device can select, from the compression algorithms, a compression algorithm that matches the scenario information. In this way, the terminal device can select corresponding compression algorithms to compress the CSI for different scenarios, thereby improving the accuracy and compression efficiency.

FIG. 10 is a schematic flowchart of another channel state information processing method provided by an embodiment of the present disclosure. The method is performed by a terminal device. As shown in FIG. 10, the method may include but is not limited to the following steps:

In step 1001, a target compression algorithm is determined.

In step 1002, CSI is compressed using a target compression algorithm to obtain compressed CSI.

In step 1003, the compressed CSI is sent to a network device.

In the present disclosure, for the specific implementations of step 1001 to step 1003, reference may be made to the detailed descriptions of any embodiment of the present disclosure, and repeated descriptions will be omitted here.

In step 1004, in response to a change in the compression algorithm used, second indication information is sent to the network device, where the second indication information is used to indicate the changed compression algorithm used.

Since radio channels have complex and changing characteristics, the scenario in which the terminal device is located may change. When the scenario in which the terminal device is located changes, the compression algorithm matching the scenario information may also change, that is, the compression algorithm for compressing CSI may also change.

In the present disclosure, in response to a change in the compression algorithm used to compress the CSI, the terminal device may send second indication information to the network device, where the second indication information is used to indicate the changed compression algorithm used. Thus, the network device can decompress the compressed CSI according to a compression algorithm indicated by the second indication information.

For example, if the compression algorithm for compressing CSI is changed to a compression algorithm B, second indication information may be sent to the network device, where the second indication information is used to indicate the compression algorithm B, so that the network device can decompress the compressed CSI according to the compression algorithm B.

In the present disclosure, the terminal device determines the target compression algorithm, and compresses the Channel State Information (CSI) using the target compression algorithm to obtain the compressed CSI. The terminal device sends the compressed CSI to the network device, and can also send second indication information to the network device in response to a change in the compression algorithm used. The second indication information is used to indicate the changed compression algorithm used. Thus, the terminal device can select a suitable compression algorithm to compress the CSI, thereby improving the accuracy and compression efficiency. And, when the compression algorithm used changes, such change is synchronized to the network device in a timely manner, so that the network device can correctly decompress the CSI according to the changed compression algorithm.

FIG. 11 is a schematic flowchart of another channel state information processing method provided by an embodiment of the present disclosure. The method is performed by a network device. As shown in FIG. 11, the method may include but is not limited to the following steps:

In step 1101, compressed CSI sent by a terminal device is received, where the compressed CSI is obtained by the terminal device through compression of CSI using a target compression algorithm.

In the present disclosure, a plurality of compression algorithms for compressing CSI may be pre-configured in the terminal device. The terminal device may determine the target compression algorithm from the plurality of compression algorithms, and compress the CSI using the target compression algorithm to obtain the compressed CSI, and send the compressed CSI to the network device. Thus, the network device can receive the compressed CSI sent by the terminal device.

In the present disclosure, the network device receives the compressed CSI sent by the terminal device, and the compressed CSI is obtained by the terminal device through compression of the CSI using the target compression algorithm. Thus, the terminal device can select a suitable compression algorithm to compress the CSI, thereby improving accuracy and compression efficiency.

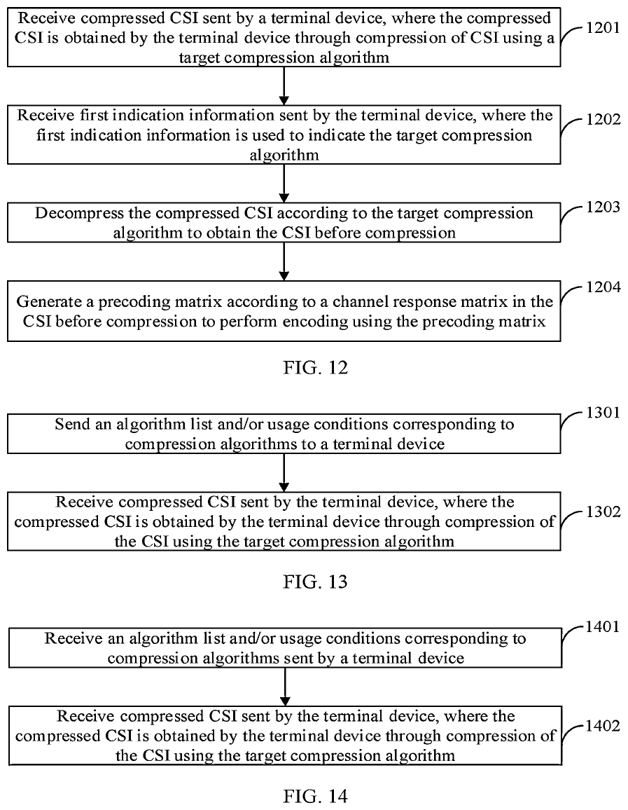

FIG. 12 is a schematic flowchart of another channel state information processing method provided by an embodiment of the present disclosure. The method is performed by a network device. As shown in FIG. 12, the method may include but is not limited to the following steps:

In step 1201, compressed CSI sent by a terminal device is received, where the compressed CSI is obtained by the terminal device through compression of CSI using a target compression algorithm.

In the present disclosure, for the specific implementations of step 1201, reference may be made to the detailed descriptions of any embodiment of the present disclosure, and repeated descriptions will be omitted here.

In step 1202, first indication information sent by the terminal device is received, where the first indication information is used to indicate the target compression algorithm.

In the present disclosure, the terminal device can send first indication information to the network device, and the first indication information can be used to indicate a target compression algorithm. That is, the terminal device indicates to the network device the target compression algorithm used for compressing CSI through the first indication information, so that the network device can receive the first indication information sent by the terminal device.

It should be noted that the above steps 1201 to 1202 may be performed sequentially in the above order, or step 1202 may be performed first and then step 1201 is performed, or step 1201 and step 1202 may be performed in parallel, and the present disclosure does not limit this.

In step 1203, the compressed CSI is decompressed according to the target compression algorithm to obtain the CSI before compression.

In the present disclosure, the network device can determine the target compression algorithm used by the terminal device for compressing the CSI based on the first indication information, and decompress the compressed CSI according to the target compression algorithm to obtain the CSI before compression.

In step 1204, a precoding matrix is generated according to a channel response matrix in the CSI before compression to perform encoding using the precoding matrix.

In the present disclosure, the network device can obtain the channel response matrix from the CSI before compression, and generate the precoding matrix according to the channel response matrix, and then perform encoding according to the precoding matrix. Thus, through the precoding, the signal energy can be concentrated near the terminal device, effectively overcoming attenuation and loss, and improving system performance.

In the present disclosure, the network device receives the compressed CSI sent by the terminal device, and can also receive the first indication information sent by the terminal device, where the first indication information is used to indicate the target compression algorithm. The network device decompresses the compressed CSI according to the target compression algorithm to obtain the CSI before compression, and generates the precoding matrix according to the channel response matrix in the CSI before compression, so as to perform encoding using the precoding matrix. Thus, the terminal device can select a suitable compression algorithm to compress the CSI, thereby improving the accuracy and compression efficiency. And, the network device can decode the compressed CSI according to the target compression algorithm indicated by the first indication information, obtain the channel response matrix, and perform precoding according to the channel response matrix.

FIG. 13 is a schematic flowchart of another channel state information processing method provided by an embodiment of the present disclosure. The method is performed by a network device. As shown in FIG. 13, the method may include but is not limited to the following steps:

In step 1301, an algorithm list and/or usage conditions corresponding to compression algorithms is sent to a terminal device.

In the present disclosure, an algorithm list may be configured in the network device, where the algorithm list may include compression algorithms for compressing CSI, usage conditions corresponding to the compression algorithms, etc. The network device may send the algorithm list to the terminal device, so that the terminal device may receive the algorithm list sent by the network device and select a target compression algorithm from the algorithm list for compressing CSI.

In the present disclosure, for the specific explanations of the usage conditions of the compression algorithms, reference may be made to the detailed explanations of any embodiment of the present disclosure, and thus repeated descriptions are omitted here.

Optionally, an algorithm list may be configured in the terminal device, where the algorithm list includes compression algorithms for compressing CSI. The network device may send usage conditions of the compression algorithms to the terminal device, so that the terminal device may obtain the usage conditions corresponding to the compression algorithms and select a target compression algorithm from the compression algorithms in the algorithm list according to the usage conditions corresponding to the compression algorithms.

Optionally, an algorithm list may be configured in the network device, where the algorithm list includes compression algorithms for compressing CSI, and usage conditions of the compression algorithms are also configured. The network device may send the algorithm list and the usage conditions corresponding to the compression algorithms to the terminal device, and the terminal device may select a target compression algorithm from the compression algorithms in the algorithm list according to the usage conditions corresponding to the compression algorithms.

In step 1302, compressed CSI sent by the terminal device is received, where the compressed CSI is obtained by the terminal device through compression of the CSI using the target compression algorithm.

In the present disclosure, for the specific implementations of step 1302, reference may be made to the detailed descriptions of any embodiment of the present disclosure, and repeated descriptions will be omitted here.

It should be noted that the above steps 1301 to 1302 may be performed sequentially in the above order, or step 1302 may be performed first and then step 1301 is performed, or step 1301 and step 1302 may be performed in parallel, and the present disclosure does not limit this.

Optionally, the network device may also receive first indication information sent by the terminal device. The first indication information may be an index identity. The index identity is used to indicate the position of the target compression algorithm in the algorithm list. That is, when the terminal device indicates to the network device the target compression algorithm used for compressing the CSI, the terminal device may indicate to the network device the position of the target compression algorithm in the algorithm list. Thus, the network device determines the compression algorithm used by the terminal device for compressing the CSI based on the index identity.

In the present disclosure, the network device sends the algorithm list and/or usage conditions corresponding to the compression algorithms to the terminal device, and receives the compressed CSI sent by the terminal device, where the compressed CSI is obtained by the terminal device through compression of the CSI using the target compression algorithm. Thus, the terminal device can determine the target compression algorithm from the algorithm list according to the algorithm list and/or usage conditions corresponding to the compression algorithms received from the network device, and use a suitable compression algorithm to compress the CSI, thereby improving the accuracy and compression efficiency.

FIG. 14 is a schematic flowchart of another channel state information processing method provided by an embodiment of the present disclosure. The method is performed by a network device. As shown in FIG. 14, the method may include but is not limited to the following steps:

In step 1401, an algorithm list and/or usage conditions corresponding to compression algorithms sent by a terminal device is received.

In the present disclosure, an algorithm list may be configured in the terminal device. The algorithm list may include compression algorithms for compressing CSI, usage conditions corresponding to the compression algorithms, etc. The terminal device may send the algorithm list to the network device, and the network device may receive the algorithm list sent by the network device.

In the present disclosure, for the specific explanations of the usage conditions of the compression algorithms, reference may be made to the detailed explanations of any embodiment of the present disclosure, and thus repeated descriptions will be omitted here.

Optionally, both the terminal device and the network device may be configured with an algorithm list, where the algorithm list includes compression algorithms. The terminal device is also configured with usage conditions of the compression algorithms. The terminal device can send the usage conditions of the compression algorithms to the network device, so that the network device can obtain the usage conditions corresponding to the compression algorithms.

Optionally, an algorithm list may be configured in the terminal device. The algorithm list includes compression algorithms for compressing CSI, and usage conditions of the compression algorithms are also configured. The terminal device may send the algorithm list and the usage conditions corresponding to the compression algorithms to the network device, so that the network device may receive the algorithm list and the usage conditions corresponding to the compression algorithms sent by the network device.

In step 1402, compressed CSI sent by the terminal device is received, where the compressed CSI is obtained by the terminal device through compression of the CSI using the target compression algorithm.

In the present disclosure, for the specific implementations of step 1402, reference may be made to the detailed descriptions of any embodiment of the present disclosure, and will not be repeated here.

It should be noted that the above steps 1401 to 1402 may be performed sequentially in the above order, or step 1402 may be performed first and then step 1401 is performed, or step 1401 and step 1402 may be performed in parallel, and the present disclosure does not limit this.

Optionally, the network device may also receive first indication information sent by the terminal device. The first indication information may be an index identity. The index identity is used to indicate the position of the target compression algorithm in the algorithm list. That is, when the terminal device indicates to the network device the target compression algorithm used for compressing the CSI, the terminal device may indicate to the network device the position of the target compression algorithm in the algorithm list. Thus, the network device determines the compression algorithm used by the terminal device for compressing the CSI based on the index identity.

In the present disclosure, the network device receives the algorithm list and/or usage conditions corresponding to the compression algorithms sent by the terminal device, and receives compressed CSI sent by the terminal device, where the compressed CSI is obtained by the terminal device through compression of the CSI using the target compression algorithm. Thus, the terminal device can select a suitable compression algorithm for compressing the CSI, thereby improving accuracy and compression efficiency.

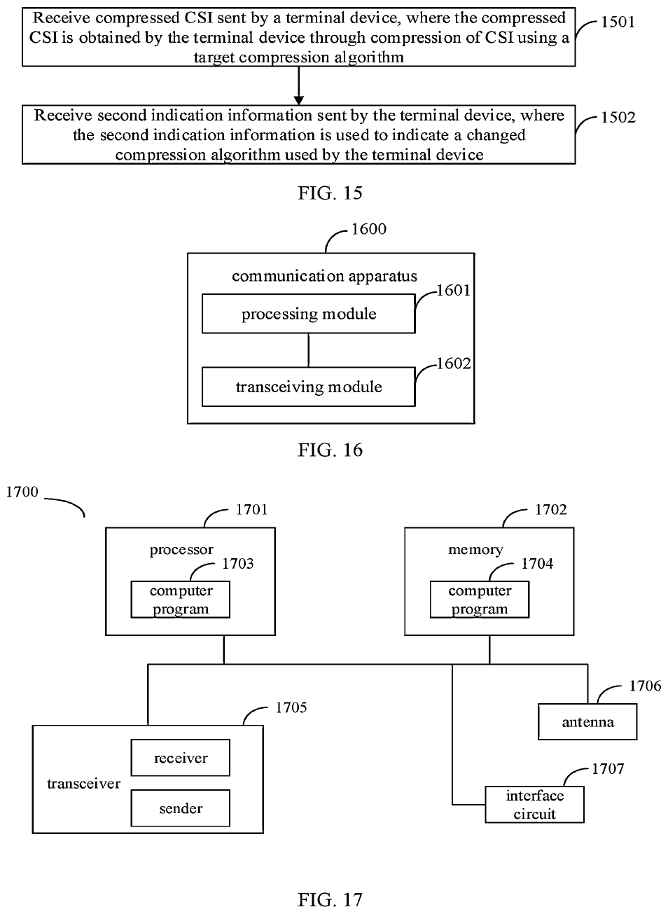

FIG. 15 is a schematic flowchart of another channel state information processing method provided by an embodiment of the present disclosure. The method is executed by a network device. As shown in FIG. 15, the method may include but is not limited to the following steps:

In step 1501, compressed CSI sent by a terminal device is received, where the compressed CSI is obtained by the terminal device through compression of CSI using a target compression algorithm.

In the present disclosure, for the specific implementations of step 1501, reference may be made to the detailed descriptions of any embodiment of the present disclosure, and repeated descriptions will be omitted here.

In step 1502, second indication information sent by the terminal device is received, where the second indication information is used to indicate a changed compression algorithm used by the terminal device.

Since radio channels have complex and changing characteristics, the scenario in which the terminal device is located may change. When the scenario in which the terminal device is located changes, the compression algorithm matching the scenario information may also change, that is, the compression algorithm for compressing CSI may also change.

In the present disclosure, in response to a change in the compression algorithm used to compress the CSI, the terminal device may send second indication information to the network device, where the second indication information is used to indicate the changed compression algorithm used. Thus, the network device can decompress the compressed CSI according to a compression algorithm indicated by the second indication information.

For example, if the compression algorithm for compressing CSI is changed to a compression algorithm B, second indication information may be sent to the network device, where the second indication information is used to indicate the compression algorithm B, so that the network device can decompress the compressed CSI according to the compression algorithm B.

In the present disclosure, the network device receives the compressed CSI sent by the terminal device, and can also receive the second indication information sent by the terminal device, where the second indication information is used to indicate the changed compression algorithm used by the terminal device. Thus, when the compression algorithm used by the terminal device is changed, such change is synchronized to the network device in a timely manner, so that the network device can correctly decompress CSI according to the changed compression algorithm.

FIG. 16 is a schematic diagram of the structure of a communication apparatus provided in an embodiment of the present disclosure. The communication apparatus 1600 shown in FIG. 16 may include a processing module 1601 and a transceiving module 1602. The transceiving module 1602 may include a sending module and/or a receiving module, the sending module is configured to implement a sending function, the receiving module is configured to implement a receiving function, and the transceiving module 1602 may implement the sending function and/or the receiving function.

It can be understood that the communication apparatus 1600 may be a terminal device, an apparatus in a terminal device, or an apparatus that can be used in conjunction with a terminal device.

The communication apparatus 1600 is arranged at the terminal device side:

the processing module 1601 is configured to: determine a target compression algorithm; and compress Channel State Information (CSI) using the target compression algorithm to obtain compressed CSI;

the transceiving module 1602 is configured to send the compressed CSI to a network device.

Optionally, the transceiving module 1602 is further configured to send first indication information to the network device, where the first indication information is used to indicate the target compression algorithm.

Optionally, the processing module 1601 is configured to:

receive an algorithm list sent by the network device, where the algorithm list includes compression algorithms; and

select the target compression algorithm from the compression algorithms in the algorithm list.

Optionally, the processing module 1601 is configured to:

receive an algorithm list sent by the network device, where the algorithm list includes compression algorithms and usage conditions corresponding to the compression algorithms; and

select the target compression algorithm from the compression algorithms according to the usage conditions corresponding to the compression algorithms.

Optionally, the processing module 1601 is configured to:

receive usage conditions corresponding to compression algorithms sent by the network device; and

select the target compression algorithm from the compression algorithms in the algorithm list according to the usage conditions corresponding to the compression algorithms.

Optionally, the transceiving module 1602 is further configured to send an algorithm list and/or usage conditions corresponding to compression algorithms to the network device.

Optionally, the first indication information is an index identity, where the index identity is used to indicate a position of the target compression algorithm in the algorithm list.

Optionally, the processing module 1601 is configured to:

determine scenario information of a scenario in which the terminal device is located;

match the scenario information against the usage conditions of the compression algorithms in the algorithm list; and

in response to that the scenario information satisfies a usage condition of a compression algorithm in the algorithm list, determine the compression algorithm to be the target compression algorithm.

Optionally, the usage condition includes a reference signal quality condition, and the processing module 1601 is configured to:

in response to that information of a reference signal of a serving beam or a serving cell in the scenario information satisfies the reference signal quality condition of a compression algorithm in the algorithm list, determine the compression algorithm to be the target compression algorithm.

Optionally, the reference signal quality condition includes one or more of the following:

being within a preset range of a channel quality;

being within a preset range of Reference Signal Receiving Power (RSRP);

being within a preset range of Reference Signal Receiving Quality (RSRQ);

being within a preset range of Signal to Interference plus Noise Ratio (SINR).

Optionally, the processing module 1601 is configured to: in response to that position information of the terminal device in the scenario information satisfies a position range in the usage condition of a compression algorithm in the algorithm list, determine the compression algorithm to be the target compression algorithm.

Optionally, the processing module 1601 is configured to: in response to that time information of the terminal device in the scenario information satisfies the time range in the usage condition of a compression algorithm in the algorithm list, determine the compression algorithm to be the target compression algorithm.

Optionally, the above-mentioned processing module 1601 is configured to: in response to that one or more of a serving beam identity, a serving cell identity, an antenna port, number of transmission layers, a modulation order in the scenario information matches the usage condition of a compression algorithm in the algorithm list, determine the compression algorithm to be the target compression algorithm.

Optionally, the processing module 1601 is configured to:

determining scenario information of a scenario in which the terminal device is located;

match the scenario information against the usage conditions of the compression algorithms in the algorithm list; and

in response to that the scenario information satisfies a usage condition of a compression algorithm in the algorithm list, determine the compression algorithm to be the target compression algorithm.

Optionally, the transceiving module 1602 is further configured to send second indication information to the network device in response to a change in the compression algorithm used, where the second indication information is configured to indicate the changed compression algorithm used.

In the present disclosure, the terminal device determines the target compression algorithm, compresses the CSI using the target compression algorithm to obtain compressed CSI, and sends the compressed CSI to the network device. In this way, the terminal device can select a suitable compression algorithm for compressing the CSI, thereby improving accuracy and compression efficiency.

It can be understood that the communication apparatus 1600 may be a network device, an apparatus in a network device, or an apparatus that can be used in conjunction with a network device.

The communication apparatus 1600 is arranged at the network device side:

the transceiving module 1602 is configured to receive the compressed CSI sent by the terminal device, where the compressed CSI is obtained by the terminal device through compression of the CSI using a target compression algorithm.

Optionally, the transceiving module 1602 is further used to receive first indication information sent by the terminal device, where the first indication information is used to indicate the target compression algorithm.

The apparatus may further include a processing module 1601 configured to:

decompress the compressed CSI according to the target compression algorithm to obtain the CSI before compression; and

generate a precoding matrix according to the channel response matrix in the CSI before compression to perform encoding using the precoding matrix.

Optionally, the transceiving module 1602 is further configured to send an algorithm list and/or usage conditions corresponding to compression algorithms to the terminal device.

Optionally, the transceiving module 1602 is further configured to receive an algorithm list and/or usage conditions corresponding to compression algorithms sent by the terminal device.

Optionally, the first indication information is an index identity, where the index identity is used to indicate a position of the target compression algorithm in the algorithm list.

Optionally, the transceiving module 1602 is further configured to receive second indication information sent by the terminal device, where the second indication information is used to indicate a changed compression algorithm used by the terminal device.

In the present disclosure, the network device receives compressed CSI sent by the terminal device, where the compressed CSI is obtained by the terminal device through compression of the CSI using the target compression algorithm. Thus, the terminal device can select a suitable compression algorithm to compress the CSI, thereby improving accuracy and compression efficiency.

In the present disclosure, the terminal device determines the target compression algorithm, compresses the CSI using the target compression algorithm to obtain compressed CSI, and sends the compressed CSI to the network device. In this way, the terminal device can select a suitable compression algorithm to compress the CSI, thereby improving accuracy and compression efficiency.

Optionally, the method further includes:

sending first indication information to the network device, wherein the first indication information is used to indicate the target compression algorithm.

Optionally, determining the target compression algorithm includes:

receiving an algorithm list sent by the network device, wherein the algorithm list includes compression algorithms; and

selecting the target compression algorithm from the compression algorithms in the algorithm list.

Optionally, determining the target compression algorithm includes:

receiving an algorithm list sent by the network device, wherein the algorithm list includes compression algorithms and usage conditions corresponding to the compression algorithms; and

selecting the target compression algorithm from the compression algorithms according to the usage conditions corresponding to the compression algorithms.

Optionally, determining the target compression algorithm includes:

receiving usage conditions corresponding to compression algorithms sent by the network device; and

selecting the target compression algorithm from the compression algorithms in the algorithm list according to the usage conditions corresponding to the compression algorithms.

Optionally, the method further includes: sending an algorithm list and/or usage conditions corresponding to compression algorithms to the network device.

Optionally, the first indication information is an index identity, wherein the index identity is used to indicate a position of the target compression algorithm in the algorithm list.

Optionally, determining the target compression algorithm includes:

determining scenario information of a scenario in which the terminal device is located;

matching the scenario information against usage conditions of the compression algorithms in the algorithm list; and

in response to the scenario information satisfying a usage condition of a compression algorithm in the algorithm list, determining the compression algorithm to be the target compression algorithm.

Optionally, the usage condition includes a reference signal quality condition; and in response to the scenario information satisfying the usage condition of the compression algorithm in the algorithm list, determining the compression algorithm to be the target compression algorithm includes:

in response to that information of a reference signal of a serving beam or a serving cell in the scenario information satisfies the reference signal quality condition of the compression algorithm in the algorithm list, determining the compression algorithm to be the target compression algorithm.

Optionally, the reference signal quality condition includes one or more of the following:

being within a preset range of a channel quality;

being within a preset range of Reference Signal Receiving Power (RSRP);

being within a preset range of Reference Signal Receiving Quality (RSRQ);

being within a preset range of Signal to Interference plus Noise Ratio (SINR).

Optionally, in response to the scenario information satisfying the usage condition of the compression algorithm in the algorithm list, determining the compression algorithm to be the target compression algorithm includes:

in response to that position information of the terminal device in the scenario information satisfies a position range in the usage condition of the compression algorithm in the algorithm list, determining the compression algorithm to be the target compression algorithm.

Optionally, in response to the scenario information satisfying the usage condition of the compression algorithm in the algorithm list, determining the compression algorithm to be the target compression algorithm includes:

in response to that time information of the terminal device in the scenario information satisfies a time range in the usage condition of the compression algorithm in the algorithm list, determining the compression algorithm to be the target compression algorithm.

Optionally, in response to the scenario information satisfying the usage condition of the compression algorithm in the algorithm list, determining the compression algorithm to be the target compression algorithm includes:

in response to a situation where one or more of a serving beam identity, a serving cell identity, an antenna port, number of transmission layers, a modulation order in the scenario information matches the usage condition of the compression algorithm in the algorithm list, determining the compression algorithm to be the target compression algorithm.

Optionally, determining the target compression algorithm includes:

determining scenario information of a scenario in which the terminal device is located;

matching the scenario information against usage conditions of compression algorithms in the algorithm list; and

in response to that the scenario information satisfies usage conditions of multiple compression algorithms in the algorithm list, selecting one compression algorithm from the multiple compression algorithms to be the target compression algorithm.

Optionally, the method further includes:

in response to a change in the compression algorithm used, sending second indication information to the network device, wherein the second indication information is used to indicate a changed compression algorithm used.

In the present disclosure, the network device receives the compressed CSI sent by the terminal device, the compressed CSI is obtained by the terminal device through compression of the CSI using the target compression algorithm. Thus, the terminal device selects a suitable compression algorithm to compress the CSI, thereby improving accuracy and compression efficiency.

Optionally, the method further includes:

receiving first indication information sent by the terminal device, wherein the first indication information is used to indicate the target compression algorithm;

decompressing the compressed CSI according to the target compression algorithm to obtain the CSI before compression;

generating a precoding matrix according to a channel response matrix in the CSI before compression to perform encoding using the precoding matrix.

Optionally, the method further includes:

sending an algorithm list and/or usage conditions corresponding to compression algorithms to the terminal device.

Optionally, the method further includes:

receiving an algorithm list and/or usage conditions corresponding to compression algorithms sent by the terminal device.

Optionally, the first indication information is an index identity, wherein the index identity is used to indicate a position of the target compression algorithm in the algorithm list.

Optionally, the method further includes: receiving second indication information sent by the terminal device, wherein the second indication information is used to indicate a changed compression algorithm used by the terminal device.

FIG. 17 is a schematic structural diagram of another communication apparatus provided by an embodiment of the present disclosure. The communication apparatus 1500 may be a network device, or a terminal device, or a chip, a chip system or a processor that supports a network device to implement the above methods, or a chip, a chip system or a processor that supports a terminal device to implement the above methods, etc. The apparatus may be configured to implement the methods described in the above method embodiments. For details, reference may be made to the descriptions in the above method embodiments.

The communication apparatus 1700 may include one or more processors 1701. The processor(s) 1701 may be a general-purpose processor or a special-purpose processor, etc. For example, it can be a baseband processor or a central processor. The baseband processor may be used to process communication protocols and communication data, and the central processor may be used to control the communication apparatus (such as base station, baseband chip, terminal device, terminal device chip, DU or CU, etc.), executes a computer program, and processes data for a computer program.

Optionally, the communication apparatus 1700 may further include one or more memories 1702, on which a computer program 1704 may be stored, and the processor 1702 executes the computer program 1704, so that the communication apparatus 1700 performs the methods described in the above method embodiments. Optionally, data may also be stored in the memory 1702. The communication apparatus 1700 and the memory 1702 may be provided separately or integrated together.

Optionally, the communication apparatus 1700 may further include a transceiver 1705 and an antenna 1706. The transceiver 1705 may be called a transceiving unit, a transceiving device, or a transceiving circuit, etc., and is configured to realize sending and receiving functions. The transceiver 1005 may include a receiver and a sender. The receiver may be called a receiving device or a receiving circuit, etc., and is configured to realize the receiving function; the sender may be called a sending device or a sending circuit, etc., and is configured to realize the sending function.

Optionally, the communication apparatus 1700 may further include one or more interface circuits 1707. The interface circuits 1707 are configured to receive code instructions and transmit them to the processor 1701. The processor 1701 executes the code instructions to cause the communication apparatus 1700 to perform the methods described in the above method embodiments.

The communication apparatus 1700 is a terminal device: the transceiver 1701 is configured to perform: steps 201 and 202 in FIG. 2; steps 301 and 302 in FIG. 3; steps 401 and 402 in FIG. 4; steps 502 and 503 in FIG. 5; steps 602 and 603 in FIG. 6; steps 702 and 703 in FIG. 7; steps 801 to 805 in FIG. 8; steps 1001 and 1002 in FIG. 10, etc.

The communication apparatus 1700 is a network device: the transceiver 1705 is configured to perform: step 101 in FIG. 11; steps 1201 and 1202 in FIG. 12; steps 1301 and 1302 in FIG. 13; steps 1401 and 1402 in FIG. 14; steps 1501 and 1502 in FIG. 15, etc.

In an implementation, a transceiver for implementing receiving and sending functions may be included in the processor 1701. For example, the transceiver may be a transceiving circuit, or an interface, or an interface circuit. The transceiving circuit, interface or interface circuit configured to implement the receiving and sending functions may be separate or integrated together. The above-mentioned transceiving circuit, interface or interface circuit may be used for reading and writing of codes/data, or the above-mentioned transceiving circuit, interface or interface circuit may be used for signal transmission or delivery.

In an implementation, the processor 1701 may store a computer program 1703, and the computer program 1703 is run on the processor 1701, causing the communication apparatus 1700 to perform the methods described in the above method embodiments. The computer program 1703 may be solidified in the processor 1701, in which case the processor 1701 may be implemented in hardware.

In an implementation, the communication apparatus 1700 may include a circuit, and the circuit may implement the functions of sending or receiving or communicating in the foregoing method embodiments. The processor and transceiver described in the present disclosure may be implemented in Integrated Circuit (IC), analog IC, Radio Frequency Integrated Circuit (RFIC), mixed signal IC, Application Specific Integrated Circuit (ASIC), Printed Circuit Board (PCB), electronic device, and so on. The processor and transceiver may also be manufactured using various IC process technologies, such as Complementary Metal Oxide Semiconductor (CMOS), nMetal-Oxide-Semiconductor (NMOS), Positive Channel Metal Oxide Semiconductor (PMOS), Bipolar Junction Transistor (BJT), bipolar CMOS (BiCMOS), silicon germanium (SiGe), gallium arsenide (GaAs), etc.

The communication apparatus described in the above embodiments may be a network device, or a terminal device, but the scope of the communication apparatus described in the present disclosure is not limited thereto, and the structure of the communication apparatus is not limited by FIG. 17. The communication apparatus may be a stand-alone device or may be part of a larger device. For example, the communication apparatus may be:
(1) an independent integrated circuit (IC), or a chip, or a chip system or subsystem;
(2) a collection of one or more ICs; optionally, the IC collection may further include a storage component for storing data and computer programs;
(3) ASIC, such as modem;
(4) a module that can be embedded in other device(s);
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

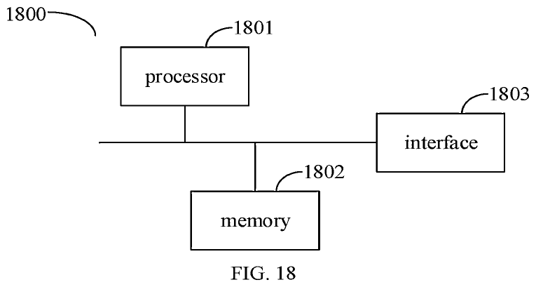

For a case where the communication apparatus can be a chip or a chip system, please refer to the schematic diagram of the chip structure shown in FIG. 18. The chip shown in FIG. 18 includes a processor 1801 and an interface 1803. The number of processors 1801 may be one or more, and the number of interfaces 1803 may be more than one.

For a case where the chip is configured to implement the functions of the terminal device in the embodiments of the present disclosure:

The interface 1803 is configured to perform: step 203 in FIG. 2; steps 303 and 304 in FIG. 3; steps 401 and 404 in FIG. 4; steps 501 and 504 in FIG. 5; steps 601 and 604 in FIG. 6; steps 701 and 704 in FIG. 7; step 806 in FIG. 8; step 906 in FIG. 9; steps 1003 and 1004 in FIG. 10, etc.

For a case where the chip is configured to implement the functions of the network device in the embodiments of the present disclosure:

The interface 1303 is configured to perform: step 1101 in FIG. 11; steps 1201 and 1202 in FIG. 12; steps 1301 and 1302 in FIG. 13; steps 1401 and 1402 in FIG. 14; steps 1501 and 1502 in FIG. 15, etc.

Optionally, the chip further includes a memory 1803, and the memory 1802 is configured to store necessary computer programs and data.

Those skilled in the art can also understand that the various illustrative logical blocks and steps listed in the embodiments of the present disclosure may be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as beyond the scope of protection of the embodiments of the present disclosure.

The present disclosure also provides a readable storage medium on which instructions are stored, and when the instructions are executed by a computer, the functions of any of the above method embodiments are implemented.

The present disclosure also provides a computer program product, which, when executed by a computer, implements the functions of any of the above method embodiments.

The above embodiments may be implemented in whole or in part by software, hardware, firmware, or any combination thereof. When implemented in software, the embodiments may be implemented in whole or in part in the form of a computer program product. The computer program product includes one or more computer programs. When the computer program is loaded and executed on a computer, processes or functions described in accordance with the embodiments of the present disclosure are generated in whole or in part. The computer may be a general-purpose computer, a special-purpose computer, a computer network, or other programmable device. The computer program may be stored in a computer-readable storage medium, or may be transferred from one computer-readable storage medium to another, for example, the computer program may be transferred from a website, computer, server, or data center to another website, computer, server or data center through wired (such as coaxial cable, optical fiber, Digital Subscriber Line (DSL)) or wireless (such as infrared, wireless, microwave, etc.) means. The computer-readable storage medium may be any available medium that can be accessed by a computer or a data storage device such as a server, data center, etc. that contains one or more available media integrated. The available medium may be magnetic medium (for example, floppy disk, hard disk, magnetic tape), optical medium (for example, high-density Digital Video Disc (DVD)), or semiconductor medium (for example, Solid State Disk (SSD)), etc.

Those of ordinary skill in the art can understand that first, second, and other numerical numbers involved in the present disclosure are only for convenience of description and are not used to limit the scope of the embodiments of the disclosure, nor to indicate a sequential order.

The plurality can be two, three, four or more, and the present disclosure is not limited thereto. In the embodiments of the present disclosure, for a kind of technical features, “first”, “second”, “third”, “A”, “B”, “C” and “D”, etc. are used to distinguish technical features in the kind of technical features, and technical features described associated with “first”, “second”, “third”, “A”, “B”, “C” and “D” are in no particular sequential order or order of size.

The corresponding relationships shown in each table in the present disclosure can be configured or predefined. Value(s) of information in each table is (are) only examples and can be configured as other values, which is not limited by the present disclosure. When configuring a corresponding relationship between information and each parameter, it is not necessarily required to configure all the corresponding relationships shown in each table. For example, in a table in the present disclosure, a corresponding relationship shown in some rows may not be configured. For another example, appropriate modified adjustments can be made based on the above table, such as splitting, merging, etc. Names of parameters shown in titles of the tables may also be other names understandable by a communication apparatus, and values or expressions of parameters may also be other values or expressions understandable by the communication apparatus. When implementing the tables, other data structures can also be used, such as arrays, queues, containers, stacks, linear lists, pointers, linked lists, trees, graphs, structure bodies, classes, heaps, hash tables or lists, and so on.

1. A channel state information processing method, wherein the method is performed by a terminal device, and the method comprises:
determining a target compression algorithm;
compressing Channel State Information (CSI) using the target compression algorithm to obtain compressed CSI; and
sending the compressed CSI to a network device.

2. The method according to claim 1, further comprising:
sending first indication information to the network device, wherein the first indication information is used to indicate the target compression algorithm.

3. The method according to claim 2, wherein determining the target compression algorithm comprises:
receiving an algorithm list sent by the network device, wherein the algorithm list comprises compression algorithms; and
selecting the target compression algorithm from the compression algorithms in the algorithm list.

4. The method according to claim 2, wherein determining the target compression algorithm comprises:
receiving an algorithm list sent by the network device, wherein the algorithm list comprises compression algorithms and usage conditions corresponding to the compression algorithms; and
selecting the target compression algorithm from the compression algorithms according to the usage conditions corresponding to the compression algorithms.

5. The method according to claim 2, wherein determining the target compression algorithm comprises:
receiving usage conditions corresponding to compression algorithms sent by the network device; and
selecting the target compression algorithm from the compression algorithms in an algorithm list according to the usage conditions corresponding to the compression algorithms.

6. The method according to claim 2, further comprising:
sending at least one of an algorithm list or usage conditions corresponding to compression algorithms to the network device.

7. The method according to claim 3, wherein the first indication information is an index identity, and wherein the index identity is used to indicate a position of the target compression algorithm in the algorithm list.

8. The method according to claim 1, wherein determining the target compression algorithm comprises:
determining scenario information of a scenario in which the terminal device is located;
matching the scenario information against usage conditions of compression algorithms in an algorithm list; and
in response to the scenario information satisfying a usage condition of a compression algorithm in the algorithm list, determining the compression algorithm to be the target compression algorithm.

9. The method according to claim 8, wherein the usage condition comprises a reference signal quality condition,
wherein in response to the scenario information satisfying the usage condition of the compression algorithm in the algorithm list, determining the compression algorithm to be the target compression algorithm comprises:
in response to that information of a reference signal of a serving beam or a serving cell in the scenario information satisfies the reference signal quality condition of the compression algorithm in the algorithm list, determining the compression algorithm to be the target compression algorithm.

10. The method according to claim 9, wherein the reference signal quality condition comprises one or more of the following conditions:
a channel quality of the reference signal of the serving beam or serving cell of the terminal device is within a preset range;
Reference Signal Receiving Power (RSRP) of the reference signal of the serving beam or serving cell of the terminal device is within a preset range of RSRP;
Reference Signal Receiving Quality (RSRQ) of the reference signal of the serving beam or serving cell of the terminal device is within a preset range of RSRQ; or
Signal to Interference plus Noise Ratio (SINR) of the reference signal of the serving beam or serving cell of the terminal device is within a preset range of SINR.

11. The method according to claim 8, wherein in response to the scenario information satisfying the usage condition of the compression algorithm in the algorithm list, determining the compression algorithm to be the target compression algorithm comprises:
in response to that position information of the terminal device in the scenario information satisfies a position range in the usage condition of the compression algorithm in the algorithm list, determining the compression algorithm to be the target compression algorithm.

12. The method according to claim 8, wherein in response to the scenario information satisfying the usage condition of the compression algorithm in the algorithm list, determining the compression algorithm to be the target compression algorithm comprises:
in response to that time information of the terminal device in the scenario information satisfies a time range in the usage condition of the compression algorithm in the algorithm list, determining the compression algorithm to be the target compression algorithm.

13. The method according to claim 8, wherein in response to the scenario information satisfying the usage condition of the compression algorithm in the algorithm list, determining the compression algorithm to be the target compression algorithm comprises:
in response to a situation where one or more of a serving beam identity, a serving cell identity, an antenna port, number of transmission layers, or a modulation order in the scenario information matches the usage condition of the compression algorithm in the algorithm list, determining the compression algorithm to be the target compression algorithm.

14. The method according to claim 1, wherein determining the target compression algorithm comprises:
determining scenario information of a scenario in which the terminal device is located;
matching the scenario information against usage conditions of compression algorithms in an algorithm list; and
in response to that the scenario information satisfies usage conditions of multiple compression algorithms in the algorithm list, selecting one compression algorithm from the multiple compression algorithms to be the target compression algorithm.

15. The method according to claim 1, further comprising:
in response to a change in a compression algorithm used by the terminal device, sending second indication information to the network device, wherein the second indication information is used to indicate a changed compression algorithm used by the terminal device.

16. A channel state information (CSI) processing method, wherein the method is performed by a network device, and the method comprises:
receiving compressed CSI sent by a terminal device, wherein the compressed CSI is obtained by the terminal device through compression of CSI using a target compression algorithm.

17. The method according to claim 16, further comprising:
receiving first indication information sent by the terminal device, wherein the first indication information is used to indicate the target compression algorithm;
decompressing the compressed CSI according to the target compression algorithm to obtain the CSI before compression; and
generating a precoding matrix according to a channel response matrix in the CSI before compression to perform encoding using the precoding matrix.

18-23. (canceled)

24. A terminal device, comprising a processor and a memory, wherein a computer program is stored in the memory, and the processor executes the computer program stored in the memory to cause the terminal device to:
determine a target compression algorithm;
compress Channel State Information (CSI) using the target compression algorithm to obtain compressed CSI; and
send the compressed CSI to a network device.

25. A non-transitory computer-readable storage medium storing instructions, wherein when the instructions are executed, the method according to claim 1 is implemented.

26. A network device, comprising a processor and a memory, wherein a computer program is stored in the memory, and the processor executes the computer program stored in the memory to cause the network device to perform the method according to claim 16.
